(19) United States
(12) Patent Application Publication
(10) Pub. No.: US 2025/0062575 A1
(43) Pub. Date: Feb. 20, 2025

(54) Electrical Connector and Electrical Connector Assembly

(71) Applicants: Tyco Electronics (Shanghai) Co., Ltd., Shanghai (CN); Tyco Electronics AMP Qingdao Ltd, Qingdao City (CN)

(72) Inventors: Xinlei (Tony) Li, Shanghai (CN); Hailong (Sanders) Yan, Shanghai (CN); Hope Lu, Shanghai (CN); Zhiyuan Gui, Shenzhen (CN); Yufang Wu, Qingdao (CN)

(73) Assignees: Tyco Electronics (Shanghai) Co., Ltd., Shanghai (CN); Tyco Electronics AMP Qingdao Ltd, Qingdao City (CN)

(21) Appl. No.: 18/804,504

(22) Filed: Aug. 14, 2024

(30) Foreign Application Priority Data
Aug. 14, 2023 (CN) 202311021407.8

(51) Int. Cl. H01R 13/6471; H01R 12/70; H01R 12/72; H01R 13/625

(52) U.S. Cl. CPC H01R 13/6471; H01R 12/7005; H01R 12/727; H01R 13/625

(57) ABSTRACT

An electrical connector includes an insulated shell having a slot in a side wall extending longitudinally, a conductive assembly, and a support member embedded in the slot. The conductive assembly includes a conductive shell assembled on the insulated shell, a plurality of contact terminals each having a base and an electrical contact segment extending from the base, and a base plate detachably connected to the insulated shell. A base of each of the contact terminals is fixed to the base plate. The conductive shell and the electrical contact segment of each of the contact terminals are held in electrical contact with each other by the base plate. A pair of free ends of the support member are fixed in the slot.

### CROSS-REFERENCE TO RELATED APPLICATIONS

This application claims the benefit of the filing date under 35 U.S.C. § 119(a)-(d) of Chinese Patent Application No. 202311021407.8, filed on Aug. 14, 2023.

### FIELD OF THE INVENTION

The present disclosure relates to an electrical connector and, more specifically, to an electrical connector and an electrical connector assembly adapted for signal transmission.

### BACKGROUND OF THE INVENTION

In the field of data communication, a connector assembly can be used to implement a signal transmission between two printed circuit boards (PCBs). As a typical example, the connector assembly comprises two connectors that fit with and cooperate with each other, which are installed on two printed circuit boards (PCBs) respectively. Then, by fitting these two connectors together, signal transmission between these two printed circuit boards is enabled.

Existing connectors typically comprise an insulated shell (such as a plastic housing and the like) and contact terminals (comprising signal terminals and grounding terminals) assembled in the insulated shell. The circuit boards are physically interconnected and electrically connected by the contact terminals of the two electrical connectors assembled in the electrical connector assembly.

In order to ensure transmission performance of high-frequency signals, electrical connector assemblies are very demanding on manufacturing tolerances for the insulation shell thereof. It is demanding on manufacturing accuracy with existing manufacturing technologies, and both difficulty in manufacturing and cost thereof are increased.

In assembling the electrical connector assembly, a bottom plane of the insulated shell of each electrical connector is flat and extends to be substantially straight. However, in practice, due to the existence of manufacturing and installation errors, and warpage for example at free ends of the shell that results from thermal deformation during welding, it is difficult to achieve expected surface flatness and overall straightness.

The current structures of the electrical connectors typically have a longitudinal length much greater than its thickness, resulting in a relatively long and thin overall structure. Therefore, during a reflow soldering process, there is a tendency of (e.g., upwards) warping deformation at both ends of the insulated shell of the electrical connector, which may easily lead to empty soldering on both sides. During the process of assembling the electrical connectors into the electrical connector assembly, respective flatness of the insulated shells of the two electrical connectors fitted with each other (for example, embodied as the flatness of the surface) will jointly determine the assembly accuracy and stability of the electrical connector assembly.

In order to avoid and reduce such problems, deformation incurred during manufacturing is generally improved by strictly monitoring the manufacturing process. The thermal deformation during the welding process is controlled, for example, by enhancing heat dissipation and controlling the single welding time and the time interval between welds, thereby reducing deformation, and improving the resulting empty soldering problem. However, the usage of this method of process control in manufacturing will lead to an increase in manufacturing costs, and still cannot avoid the generation of unqualified products.

### SUMMARY OF THE INVENTION

An electrical connector includes an insulated shell having a slot in a side wall extending longitudinally, a conductive assembly, and a support member embedded in the slot. The conductive assembly includes a conductive shell assembled on the insulated shell, a plurality of contact terminals each having a base and an electrical contact segment extending from the base, and a base plate detachably connected to the insulated shell. A base of each of the contact terminals is fixed to the base plate. The conductive shell and the electrical contact segment of each of the contact terminals are held in electrical contact with each other by the base plate. A pair of free ends of the support member are fixed in the slot.

### BRIEF DESCRIPTION OF THE DRAWINGS

The accompanying drawings, which are incorporated in and constitute a portion of the specification, illustrate certain aspects of the subject matter disclosed herein and, together with the description, facilitate interpreting some principles associated with the embodiments as disclosed. In the attached drawings:

FIG. 1 is an isometric view of an electrical connector according to an embodiment;

FIG. 2 is an exploded view of the electrical connector of FIG. 1;

FIG. 3(a) is a top view of the electrical connector of FIG. 1;

FIG. 3(b) is a bottom view of the electrical connector of FIG. 1;

FIG. 3(c) is a left view of the electrical connector of FIG. 1;

FIG. 3(d) is a right view of the electrical connector of FIG. 1;

FIG. 3(e) is a front view of the electrical connector of FIG. 1;

FIG. 3(f) is a rear view of the electrical connector of FIG. 1;

FIG. 3(g) is a cross-sectional view of an insulation shell along a line A-A section in the electrical connector as illustrated in FIG. 3(a);

FIG. 4 is an exploded view of a conductive assembly in the electrical connector of FIG. 1, with all contact terminals removed for clarity;

FIG. 5 is an isometric view of a conductive shell, in the conductive assembly of FIG. 4;

FIG. 6(a) is an isometric view of the conductive shell and the grounding terminals in the conductive shell as shown in FIG. 4;

FIG. 6(b) is a top view of the conductive shell and the grounding terminals in the conductive shell as shown in FIG. 4; and

FIG. 7 is an isometric view of an assembly structure of an electrical connector assembly according to the embodiments as disclosed.

### DETAILED DESCRIPTION

The technical solution of the present disclosure will be further explained in detail hereinafter, with specific embodiments in view of accompanying drawings as attached. In the specification, identical or similar reference numerals indicate identical or similar components, respectively. The following description of the specific implementation of this disclosure with reference to the accompanying drawings is intended to explain an overall technical concept of the disclosure, rather than being conceived as a limitation of the disclosure.

In addition, in the following detailed description, for facilitating explanation, many specific details are set forth so as to provide a comprehensive understanding of the embodiments as disclosed. However, it is apparent that one or more embodiments can also be implemented without these specific details. In other cases, known structures and devices are illustrated so as to simplify the accompanying drawings.

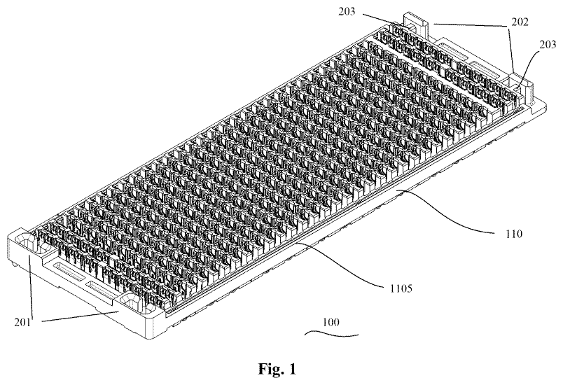

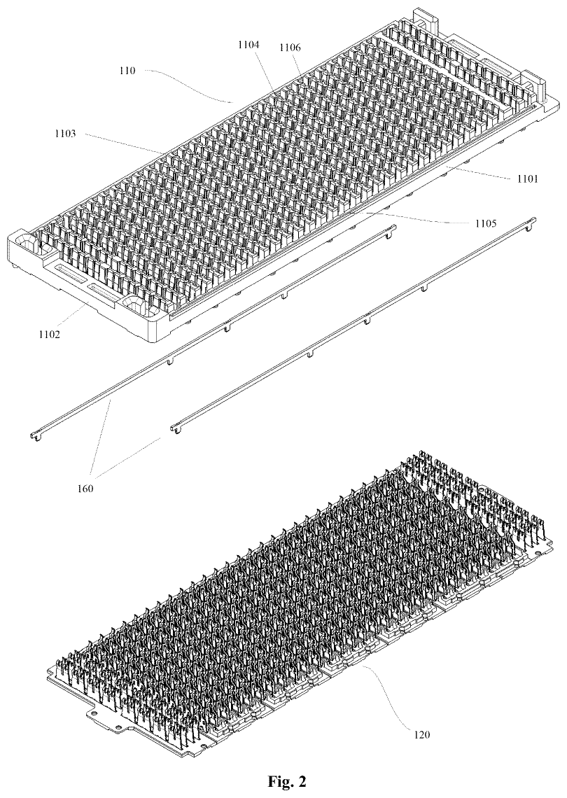

According to an overall technical concept as disclosed herein, for example, as illustrated in FIGS. 1 and 2, an electrical connector 100 is provided, comprising an insulated shell 110 and a conductive assembly 120. In exemplary embodiments, the insulated shell 110 is for example formed by an insulating material and defines a first side and second side thereof opposite to each other, in a normal direction orthogonal to both a longitudinal direction which is in its length direction and a transverse direction which is perpendicular to the longitudinal direction.

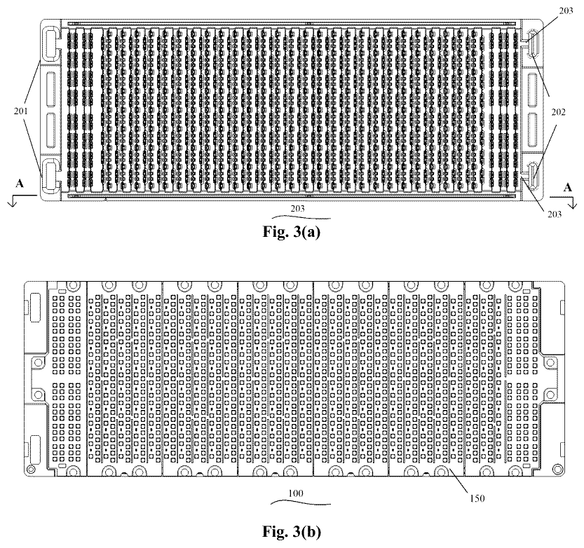

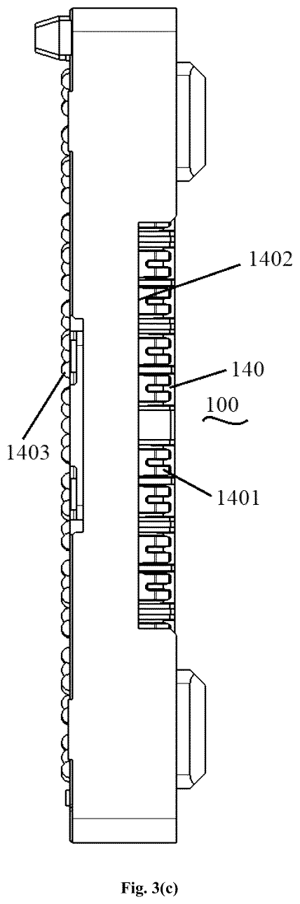

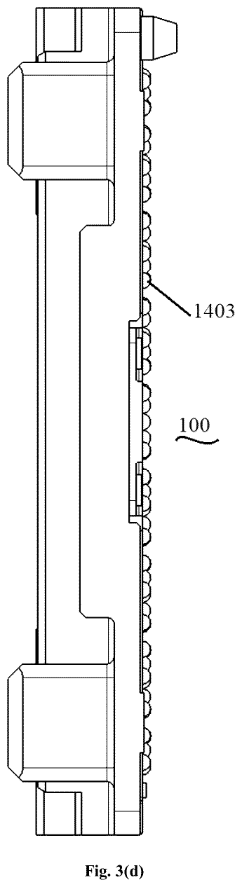

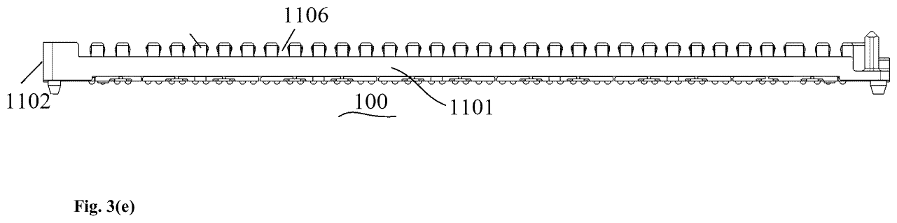

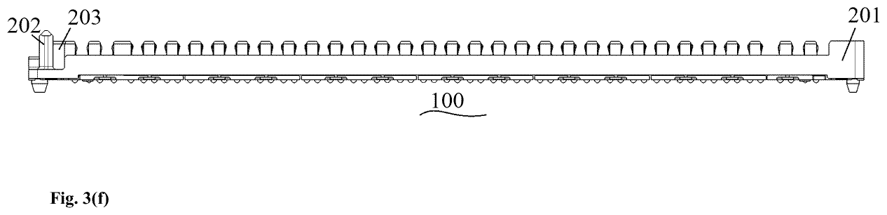

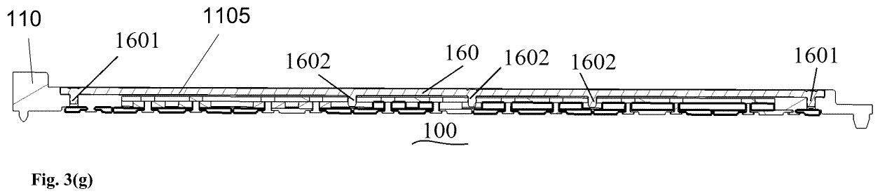

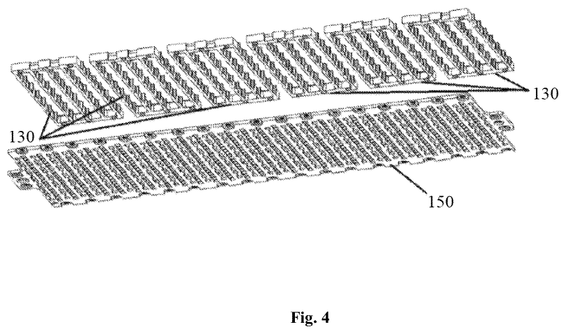

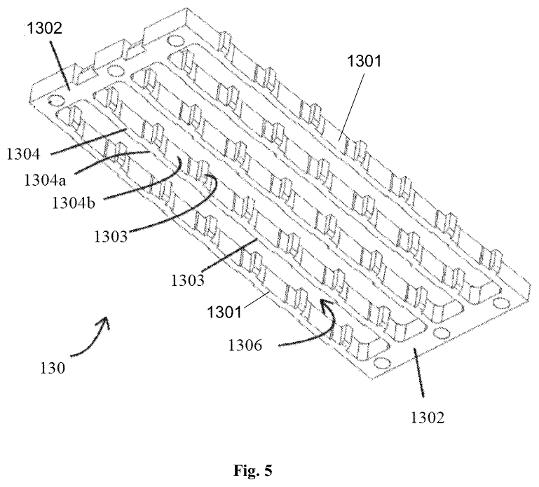

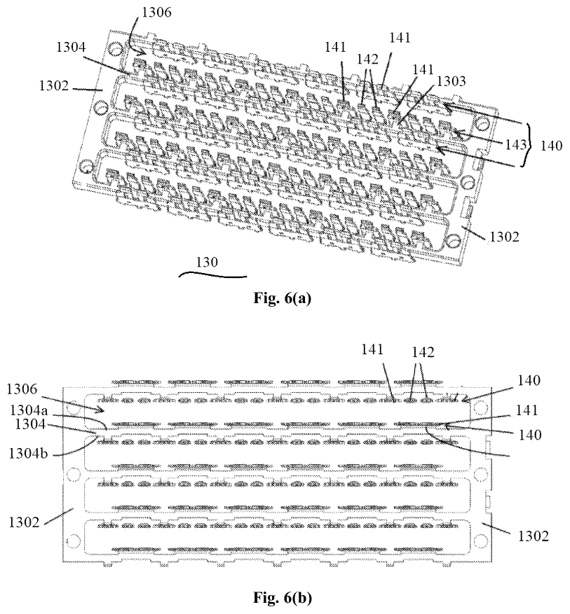

In exemplary embodiments, the conductive assembly 120 comprises, for example, at least one conductive shell 130 which is assembled on the insulated shell 110, as shown in FIGS. 4 and 5, a plurality of contact terminals 140, shown in FIGS. 6(a) and 6(b), and a base plate 150, shown in FIG. 3(b), which is detachably connected to the insulated shell 110.

By way of example, as shown in FIGS. 6(a) and 6(b), the plurality of contact terminals 140 include a plurality of grounding terminals 141 and a plurality of signal terminals 142, as well as at least one power supply terminal 143. The plurality of grounding terminals 141 and the plurality of signal terminals 142 may be arranged in an intermediate area of the electrical connector 100, while the power supply terminal 143 may for example be arranged in a margin area of the electrical connector 100.

In an embodiment, the plurality of contact terminals 140 are, for example, arranged in plurality of rows, more typically arranged in an array. By way of example, each contact terminal 140 has a base 1401 and an electrical contact segment 1402 extending from the base 1401, as shown in FIG. 3(c). The base 1401 is, for example, at least partially exposed from the first side, and the electrical contact segment 1402 is, for example, at least partially exposed from the second side for electrical contact with a respective contact terminal 140 of another electrical connector 100 mating therewith.

As shown in FIGS. 6(a) and 6(b), the plurality of contact terminals 140 include at least the plurality of grounding terminals 141 for achieving grounding of the electrical connector 100. The base plate 150 is provided, for example, on the second side of the insulated shell 110. By way of example, the respective bases 1401 of the plurality of grounding terminals 141 are fixed to the base plate 150, for example, with solder balls or welding balls 1403 shown in FIGS. 3(c) and 3(d) formed by welding, and the conductive shell 130 and respective electrical contact segments 1402 of the plurality of grounding terminals 141 are held to be electrically connected in contact with each other by the base plate 150.

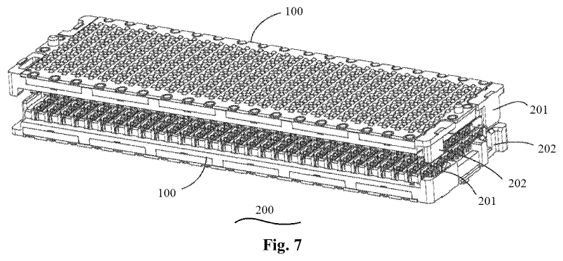

The electrical connector 100 provided in this embodiment as disclosed improves the electrical performance of an entire electrical connector assembly 200, shown in FIG. 7, by forming the conductive shell 130 on the insulated shell 110, and by electrically connecting all grounding terminals 141 together through contact between the conductive shell 130 and all grounding terminals 141.

While improving signal transmission performance, the high requirement on manufacturing tolerances for the insulated shell 110, which is for example formed by plastics in the prior art so as to ensure signal transmission performance for high-frequency signals, can be reduced. Therefore, the impact of manufacturing tolerance for plastic insulated shell 110 and all parts (e.g., terminals) is improved. Moreover, the impedance of the entire electrical connector 100 can be improved, thereby improving the transmission of high-speed signals, by providing the base plate 150 to which respective bases 1401 of the plurality of grounding terminals 141 are jointly fixed.

The electrical connector 100 can effectively enhance an overall flexural rigidity of the insulation shell 110 of the electrical connector 100, by additionally providing a slot 1105 that is recessed in at least one side wall and a support member 160 embedded in the slot 1105, as shown in FIG. 2. The support member 160, for example, is in the form of an elongated member typically arranged in the longitudinal direction. As such, coplanarity of the electrical connector 100 (for example, coplanarity thereof at all welding locations) is ensured, effectively avoiding occurrence of empty soldering or missing solder, and reducing the welding defect rate, thereby achieving improved product quality.

In further embodiments, for example, the electrical connector 100 is formed with a slot 1105 in at least one side wall 1101 extending in the longitudinal direction thereof, and the insulated shell of the electrical connector is also provided with a support member 160 embedded in the slot 1105, with the two free ends 1601 of the support member 160 shown in FIG. 3(g) being fixed in the slot 1105. In an embodiment, each support member 160 is an elongated member arranged along the longitudinal direction.

When the insulation shell 110 is heated during the manufacturing process, resulting in a tendency of upwards warping deformation thereof at both ends in the length direction, because the two free ends 1601 of the support member 160 are fixed in the slot 1105, the support member 160 tensions the ends of the insulated shell 110 outwards in the length direction. The overall rigidity of the insulated shell 110 is enhanced, and both overall flatness and surface flatness thereof in the length direction can be improved, so as to resist the tendency of thermal deformation during surface mounting (for example, reflow soldering) and avoid defects such as empty soldering and the like. This ensures coplanarity of the electrical connector 100 (for example, coplanarity thereof at all welding locations), reducing the welding defect rate and improving product quality.

As shown in FIG. 2, by way of example, the electrical connector 100 is formed with two slots 1105 respectively in the two side walls 1101 extending longitudinally. The at least one support member 160 includes two support members 160 embedded respectively in the two slot 1105, each support member 160 being an elongated member arranged longitudinally. The two free ends 1601 of each support member 160 are fixed in the respective slot 1105, as shown in FIG. 3(g). As such, a more uniform support for the overall rigidity of the entire insulated shell 110 is achieved, by providing two parallel elongated support members 160 respectively in the two side walls 1101 opposite to each other.

It should be noted that, since various components/structures (such as grounding terminals 141, signal terminals 142, terminal channels, etc.) in the electrical connector 100 as provided in the present disclosure are presented in plural forms in the drawings, then for clarity, each reference numeral in the drawings merely identifies one component/structure or two identical components/structures, rather than identifying/indicating all identical components/structures. For example, in the drawings, merely a limited number of contact terminals 140 and a limited number of terminal channels and the like are identified/indicated. However, those skilled in the art should be aware that these reference numerals can also refer to components/structures that are not identified in the drawings but are identical to the components/structures as identified by these reference numerals.

In exemplary embodiments, for example, the insulated shell 110 is formed by an insulating material such as plastic and the like.

Moreover, in exemplary embodiments, for example as illustrated in FIG. 2, the insulated shell 110 may comprise a frame shaped body portion 1103 extending in the length direction, and the body portion 1103 is provided with two side walls 1101 extending in the length direction and opposite to each other, as well as two end walls 1102 located respectively at two opposite ends in the length direction (i.e., first end and second end opposite to each other). In a frame shaped space defined or delimited collectively/jointly by the two side walls 1101 and two end walls 1102 of the frame shaped body portion 1103, a plurality of columns of first partition walls 1104 are further formed, which for example extend parallel to each other in the transverse direction (perpendicular to the length direction, and also known as the width direction of the insulating shell 110). The first partition walls 1104 are connected to the two side walls 1101 and are spaced apart from each other in the length direction.

In the frame shaped space, the plurality of columns of first partition walls 1104 are used to define a plurality of first terminal installation channels 1106 which are configured to accommodate the plurality of contact terminals 140, with each first terminal installation channel 1106 for example accommodating at least one column of contact terminals 140, typically one column or two columns of contact terminals 140. The plurality of contact terminals 140 are arranged in multiple rows spaced apart from each other by the plurality of first partition walls 1104, more typically arranged in an array alternately interposed between the plurality of first partition walls 1104.

In exemplary embodiments, the at least one support member 160 is, for example, a metal sheet or a metal strip. As such, the at least one support member 160 is essentially an elongated member arranged longitudinally and formed by metal material. As shown in FIG. 3(g), in the exemplary embodiment as illustrated, for example, the two free ends 1601 of each support member 160 are respectively fixed, in an interference fit, into the slot 1105 of the insulated shell 110.

Due to the material characteristics of each metal support member 160 itself, each metal support member 160 has a certain degree of bending stiffness or flexural rigidity. Thus, it is not easy to significantly deform in a direction perpendicular to an extension direction thereof along which each metal support 160 extends under the influence of heat from reflow soldering. Additionally, because the two free ends 1601 of each metal support member 160 and walls of the respective slot 1105 of the insulated shell 110 tightly abut against each other and interfere with each other, each metal support member 160 exerts or applies an outwards force onto the wall of respective slot 1105, ensuring that the metal support member 160 imparts additional flexural rigidity to the insulating housing 110 in the manufacturing of the electrical connector 100 for example during the process of the reflow soldering. Thus, the warping deformation is suppressed in the normal direction orthogonal to both the longitudinal direction which is in its length direction and the transverse direction which is perpendicular to the longitudinal direction, such that both the whole insulated shell 110 and even the electrical connector 100 are kept in a flat state, which is conducive to smooth welding and avoids empty soldering or false welding (i.e., insufficient solder) at both ends.

As shown in FIG. 3(g), each support member 160 is further provided with a plurality of protruding structures 1602 spaced apart from one another and also spaced apart from both free ends 1601 in the extension direction thereof along which the support member 160 extends, and the plurality of protruding structures 1602 are fitted to a plurality of holes formed in the base plate 150, respectively.

By way of example, the plurality of protruding structures 1602 are fixedly and permanently (i.e., non-detachably) mounted, in a positive fit, to the base plate 150. In further embodiments, the plurality of protruding structures 1602 are respectively formed to be a plurality of barbed protrusions which are fixedly and permanently, i.e., non-detachably, inserted into the plurality of holes. In more specific embodiments, the plurality of barbed protrusions for example cooperate with the respective hole walls of the plurality of holes to form an interference fit therebetween.

By additionally providing the plurality of protruding structures 1602 that are respectively fitted to (for example hole walls of the plurality of holes of) the base plate 150 in the length direction of each metal support 160 as illustrated, an additional support relative to the base plate 150 is applied to the insulation shell 110 at a plurality of locations along the length of each metal support 160. This further enhances the flexural rigidity of the insulation shell 110 along its length direction. In an embodiment, the fit between each barbed protrusions and the respective hole on the base plate 150 is a non-detachable permanent fit, and the fit between each metal support member 160 and the electrical connector 100 is firm and ensures that the at least one metal support member 160 and the insulation shell 110 are essentially an integrated structure. This avoids the risk of accidental removal of any metal support member 160 from the respective slot 1105 of the insulation shell 110.

In another embodiment, the plurality of protruding structures 1602 may further be secured to the base plate 150 of the electrical connector 100 and locked thereto in a detachable but secure manner in a snap-fit, by passing through the slots 1105 in the insulated shell 110 and then being mounted to the base plate 150. By way of example, each of the plurality of protruding structures 1602 is in a form of a hook-shaped structure and snap fits into a respective one of a plurality of bayonets provided on the base plate 150. As such, with such a setting, it is also possible to apply an additional support relative to the base plate 150 to the insulation shell 110 of the electrical connector 100 at a plurality of locations along the length of the metal support 160, further enhancing the flexural rigidity of the insulation shell 110 along its length direction. However, this type of fit, e.g., the locking manner in snap-fit with the bayonets on the base plate 150, is a detachable and thus non-permanent fit. Therefore, the at least one metal support 160 does not form a completely integrated structure with the insulation shell 110, only providing limited additional flexural rigidity. Especially, the impartation of additional flexural rigidity still mainly occurs at the two free ends 1601 where the metal support 160 and the respective slot 1105 wall form a permanent interference fit.

In another embodiment, each support member 160 may also be non-removably fixed, at both free ends thereof, into the respective slot 1105 of the insulated shell 110, by bonding or inserting thereto, respectively. Further, the two free ends 1601 of each support member 160 may also be fixed in the slot 1105 of the insulated shell 110 by bonding or inserting, respectively, and cannot be removed. Furthermore, the plurality of protruding structures 1602 (comprising but not limited to the plurality of barbed protrusions) may be optionally additionally provided in the extension direction of the at least one metal support 160, which are in turn fitted to, or fixed in a non-removable manner (by bonding or inserting) to the base plate 150, respectively. As such, it is also possible to impart additional flexural rigidity to the insulation shell 110 at the wall of the respective slot 1105 that is bonded with the two free ends 1601 of each metal support 160, by permanently bonding the two free ends 1601 of the metal support 160 with the insulation shell 110. This ensures that, in the manufacturing of the electrical connector 100 for example during the process of the reflow soldering, the warping deformation (especially at both ends of the insulated shell 110) in the normal direction is thereby suppressed, such that both the whole insulated shell 110 and the electrical connector 100 are kept in a flat state. This is conducive to smooth welding and avoids empty soldering or false welding (i.e., insufficient solder) at both ends.

In an embodiment, an additional support relative to the base plate 150 is applied to the insulation shell 110 of the electrical connector 100 at a plurality of locations along the length of the metal support 160, further enhancing the flexural rigidity of the insulation shell 110 along its length direction. Moreover, an additional support relative to the base plate 150 is applied to the insulation shell 110 of the electrical connector 100 at plurality of locations along the length of each metal support 160, further enhancing the flexural rigidity of the insulation shell 110 along its length direction. Considering that the fit between each barbed protrusions and the respective hole on the base plate 150 is a non-detachable permanent fit, the fit between each metal support member 160 and the electrical connector 100 is firm and thus ensures that the at least one metal support member 160 and the insulation shell 110 are essentially formed to be an integrated structure, without any risk of accidental removal of any metal support member 160 from the respective slot 1105 of the insulation shell 110.

As illustrated in FIGS. 4-6(b), in the shown embodiments, at least one conductive shell 130 is positioned between the insulated shell 110 and the base plate 150, and may be assembled to the insulated shell 110, for example, by at least partially inserting it into the insulated shell 110. By way of example, each conductive shell 130 is connected to respective ones of the plurality of grounding terminals 141 in a contact conductive manner, for example, so as to connect the plurality of grounding terminals 141 together. The at least one conductive shell 130 may be provided in the intermediate area of the electrical connector 100.

As illustrated in FIG. 5, in the exemplary embodiments as illustrated, each conductive shell 130 comprises, for example, two second side walls 1301 arranged in parallel and two second end walls 1302, each of which is connected between respective ends, at the same side, of the two side walls 1301. The two side walls 1301 and the two second end walls 1302 jointly/cooperatively define a second frame shaped space. In the second frame shaped space, a plurality of columns of second partition walls 1304 are further formed, which for example extend parallel to the second side walls 1301 and are connected to the two side walls 1301 and are spaced apart from each other in a direction along which the plurality of columns of second partitions 1302 extend.

As such, in the second frame shaped space, the plurality of columns of second partition walls 1304 are used to define a plurality of second terminal installation channels 1306 which allow the plurality of contact terminals 140 (especially respective electrical contact segments 1402 of the plurality of contact terminals 140) to pass through, as shown in FIGS. 6(a) and 6(b). Each second terminal installation channel 1306 accommodates at least one column of contact terminals 140, typically one column or two columns of contact terminals 140. The plurality of contact terminals 140 are arranged in multiple rows spaced apart from each other by the plurality of second partition walls 1304, more typically arranged in an array alternately interposed between the plurality of second partition walls 1304. Moreover, for example, a plurality of conductive protrusions 1303 are formed on side surfaces 1304a and 1304b of each second partition 1304 and are respectively electrically connected in contact with the plurality of grounding terminals 141 passing through the plurality of second terminal installation channels 1306, thereby improving electrical shielding performance of the electrical connector 100.

In the shown embodiments, the conductive shell 130 may be formed integrally with the plurality of conductive protrusions 1303 so as to simplify the manufacturing process.

A plurality of conductive shells 130 may be formed side by side and parallel to each other on the insulated shell 110 and are for example arranged such that the second side walls 1301 of each conductive shell 130 are aligned along the transverse direction, i.e., the width direction of the insulated shell 110. As illustrated in FIG. 4, by way of example, six conductive shells 130 are formed side by side and parallel to one another on the insulated shell 110. Of course, in other embodiments, other quantities of conductive shells 130 may also be formed on the insulated shell 110 as per actual requirements. Because the conductive protrusions 1303 are respectively provided on the two sides of each vertical wall of the conductive shells 130, then, there are also respective conductive protrusions 1303 provided between outermost vertical walls of adjacent conductive shells 130, which can be used to contact and connect the grounding terminal 141 located between these two adjacent conductive shells 130.

By way of example, the conductive shells 130 may be formed by physical vapor deposition (PVD) technology or Molded Interconnect Device (MID) technology and assembled onto the insulated shell 110. MID technology refers to the technology of manufacturing or installing electrical components, e.g., metal coatings, on surface(s) of an injection molded plastic shell, so as to combine the electrical interconnection function of components with the mechanical support function of plastic shell. Of course, in other embodiments, other techniques that are capable of metalizing a plastic surface may also be employed to form conductive shell(s) 130 on the insulated shell 110.

In the shown embodiments, each conductive shell 130 is a metalized shell formed by depositing a layer of metal on a plastic shell, and the insulated shell 110 is a plastic shell. In exemplary embodiments, the conductive shell 130 is made by depositing a layer of metallic nickel on the plastic shell. Of course, in other embodiments, the conductive shell 130 may also be manufactured by depositing other conductive metal material, or by die-casting or casting other conductive pure metal material.

FIG. 7 schematically illustrates an assembly structure of an electrical connector assembly 200 according to the embodiments as disclosed. The electrical connector assembly 200 includes two electrical connectors 100 as described above. The insulated shell 110 of each electrical connector 100 has a body portion 1103, which extends in a length direction thereof and is provided with a first end and a second end opposite to each other in the length direction to function as two end walls of the insulated shell 110 as previously described. The insulated shell 110 has a first guiding structure, comprising at least one guiding slot 201 formed to be concave into the first end, and a second guiding structure, comprising at least one guiding column 202 protruding at the second end. By way of example, shape and dimensions of respective guiding slot 201 and respective guiding column 202 of one of the two electrical connectors 100 are adapted to fit with those of respective guiding slot 201 and respective guiding column 202 of the other of the two electrical connectors 100, such that the two electrical connectors 100 fit and engage with each other.

By way of example, respective guiding slots 201 on the insulated shell 110 of a single electrical connector 100 may be the same as illustrated in FIG. 1, or alternatively may be different as illustrated in FIG. 7. Furthermore, by way of example, the respective guiding columns 202 on the insulated shell 110 of a single electrical connector 100 may be the same as illustrated in FIG. 1, or alternatively may be different as illustrated in FIG. 7.

In further embodiments, for example, as illustrated, the at least one guiding slot 201 comprises two guiding slots 201 spaced apart from each other in a width direction of the body portion 1103; and the at least one guiding column 202 comprises two guiding columns 202 spaced apart from each other in the width direction of the body portion 1103.

In an embodiment, for example, each guiding slot 201 is formed in a U-shape whose opening opens towards the second end, with a connection portion 203 being also formed between each guiding column 202 and the body portion 1103, as shown in FIG. 1. The opening of the U-shape is shaped and dimensioned to be adapted to accommodate the connection portion 203.

With such a setting, when the two electrical connectors 100 are assembled together, the at least one guiding column 202 of either electrical connector 100 is adapted to engage with the at least one guiding slot 201 of the other electrical connector 100 so as to guide the two electrical connectors 100 to be assembled relative to each other in position. In other words, the at least one guiding slot 201 of an electrical connector 100 (hereinafter referred to as the first electrical connector) is adapted to receive the at least one guiding column 202 of another electrical connector 100 (hereinafter referred to as the second electrical connector), and the at least one guiding column 202 of the first electrical connector is adapted to be guided and inserted into the at least one guiding slot 201 of the second electrical connector so as to be finally accepted therein in place, ensuring that the two electrical connectors 100 are properly assembled with respect to each other.

Considering that the electrical connector assembly 200 as provided in another aspect of this disclosure comprises two aforementioned electrical connectors 100, then, the electrical connector assembly 200 also has the advantage of the aforementioned electrical connector 100, which will not be repeated.

It may be understood by those skilled in the art that the embodiments described above are exemplary and may be improved by those skilled in the art, and the structures described in various embodiments can be freely combined without conflict in structure or principle.

Although the disclosure is described in view of the attached drawings, the embodiments illustrated in the attached drawings are intended to illustrate embodiments of the disclosure and should not be understood as a limitation of the disclosure.

Although some embodiments of the general concept as disclosed herein have been illustrated and described, those skilled in the art will understand that modifications can be made without departing from the principles and spirit of the general concept of this disclosure. The breadth and scope of the disclosure should not be limited by any of the above-mentioned exemplary embodiments but should be limited merely by the following claims and their equivalents. It should be noticed that the wording “comprising” does not exclude other components or steps, and the wording “a/an” or “one” does not exclude multiple or a plurality.

What is claimed is:

1. An electrical connector, comprising:
an insulated shell having a slot in a side wall extending longitudinally;
a conductive assembly including:
a conductive shell assembled on the insulated shell;
a plurality of contact terminals each having a base and an electrical contact segment extending from the base; and
a base plate detachably connected to the insulated shell, the base of each of the contact terminals is fixed to the base plate, the conductive shell and the electrical contact segment of each of the contact terminals are held in electrical contact with each other by the base plate; and a support member embedded in the slot, a pair of free ends of the support member are fixed in the slot.

2. The electrical connector of claim 1, wherein the contact terminals include a plurality of grounding terminals.

3. The electrical connector of claim 1, wherein the slot is one of a pair of slots in a pair of side walls of the insulated shell, the support member is one of a pair of support members that are each embedded in one of the slots.

4. The electrical connector of claim 3, wherein each of the support members has a pair of free ends fixed in the one of the slots.

5. The electrical connector of claim 1, wherein the free ends of the support member are interference fit in the slot.

6. The electrical connector of claim 1, wherein the support member has a plurality of protruding structures spaced apart from one another and spaced apart from the free ends in an extension direction of the support member.

7. The electrical connector of claim 6, wherein the protruding structures are fitted to a plurality of holes in the base plate.

8. The electrical connector of claim 6, wherein the protruding structures are fixed and permanently mounting in a positive fit to the base plate.

9. The electrical connector of claim 7, wherein the protruding structures are a plurality of barbed protrusions fixed and permanently installed in the holes of the base plate.

10. The electrical connector of claim 9, wherein the barbed protrusions are interference fit with a plurality of hole walls of the holes of the base plate.

11. The electrical connector of claim 7, wherein the protruding structures are detachably fixed to the base plate and locked to the base plate in a snap fit.

12. The electrical connector of claim 11, wherein each of the protruding structures is a hook-shaped structure and snap fits into one of a plurality of bayonets on the base plate.

13. The electrical connector of claim 1, wherein the support member is non-removably fixed at both free ends in the slot.

14. The electrical connector of claim 1, wherein the support member is a metal sheet or a metal strip.

15. An electrical connector assembly, comprising:
a pair of electrical connectors each including an insulated shell, the insulated shell has:
a body portion extending in a length direction and having a first end and a second end opposite the first end in the length direction;
a first guiding structure having a guiding slot that is concave into the first end; and
a second guiding structure having a guiding column protruding at the second end, the guiding slot of one of the insulated shells fits with the guiding column of the other of the insulated shells and the electrical connectors fit and engage with each other.

16. The electrical connector assembly of claim 15, wherein the insulated shell of each of the electrical connectors has a slot in a side wall extending longitudinally and each of the electrical connectors has a support member embedded in the slot.

17. The electrical connector assembly of claim 16, wherein each of the electrical connectors has a conductive assembly including:
a conductive shell assembled on the insulated shell;
a plurality of contact terminals each having a base and an electrical contact segment extending from the base; and
a base plate detachably connected to the insulated shell, the base of each of the contact terminals is fixed to the base plate, the conductive shell and the electrical contact segment of each of the contact terminals are held in electrical contact with each other by the base plate.

18. The electrical connector assembly of claim 15, wherein the guiding slot is one of a pair of guiding slots spaced apart from each other in a width direction of the body portion and the guiding column is one of a pair of guiding columns spaced apart from each other in the width direction.

19. The electrical connector assembly of claim 18, wherein the guiding slots are each formed in a U-shape and open toward the second end.

20. The electrical connector assembly of claim 19, wherein a connection portion is formed between each guiding column and the body portion, the U-shape of each of the guiding slots accommodates one of the connection portions.
